(19) United States
(12) Patent Application Publication
(10) Pub. No.: US 2019/0081342 A1
(43) Pub. Date: Mar. 14, 2019

(54) METHOD OF PRODUCING MEMBRANE ELECTRODE ASSEMBLY

(71) Applicant: TOYOTA JIDOSHA KABUSHIKI KAISHA, Toyota-shi (JP)

(72) Inventors: Satoshi KADOTANI, Seto-shi (JP); Kazuki FUJII, Nagoya-shi (JP); Tatsuo HOSHINO, Chiryu-shi (JP)

(73) Assignee: TOYOTA JIDOSHA KABUSHIKI KAISHA, Toyota-shi (JP)

(21) Appl. No.: 16/122,187

(22) Filed: Sep. 5, 2018

(30) Foreign Application Priority Data
Sep. 13, 2017 (JP) 2017-175363

(51) Int. Cl. H01M 8/1072; H01M 8/1023; H01M 4/88; H01M 8/1058; H01M 4/92; H01M 8/1004

(52) U.S. Cl. CPC H01M 8/1072; H01M 8/1023; H01M 4/881; H01M 2008/1095; H01M 4/925; H01M 8/1004; H01M 8/1058

(57) ABSTRACT

A method of producing a membrane electrode assembly including an electrolyte film, including: a process of obtaining a membrane body by forming an electrolyte resin precursor which is a precursor of an electrolyte resin used in the electrolyte film into a film form; and a hydrolysis process of obtaining the electrolyte film by hydrolyzing the membrane body, wherein the hydrolysis process includes a process of passing the membrane body through a first tank in which an alkaline aqueous solution is accommodated and a process of passing the membrane body through second tanks in which an aqueous solution in which a water-soluble hydroxy radical elimination accelerator is dissolved in advance is accommodated after the membrane body is passed through the first tank.

### INCORPORATION BY REFERENCE

The disclosure of Japanese Patent Application No. 2017-175363 filed on. Sep. 13, 2017 including the specification, drawings and abstract is incorporated herein by reference in its entirety.

### BACKGROUND

### 1. Technical Field

The present disclosure relates to a method of producing a membrane electrode assembly used in a fuel cell.

### 2. Description of Related Art

In a fuel cell, hydrogen gas supplied to an anode side or some oxygen supplied to a cathode side may pass through an electrolyte film, reach the other electrode side, and hydrogen and oxygen may exist together on the other electrode side. In this case, on the other electrode side, hydrogen peroxide and hydrogen peroxide radicals (.OH: hydroxy radicals) according to radicalization of hydrogen peroxide may be generated. The hydroxy radicals deteriorate the electrolyte film. Therefore, in order to reduce such deterioration, cerium (Ce) is incorporated into the electrolyte film. In the electrolyte film, trivalent cerium ions react with hydroxy radicals to generate tetravalent cerium ions and water, and the hydroxy radicals are eliminated. In Japanese Unexamined Patent Application Publication No. 2009-286840 (JP 2009-286840 A), at a predetermined time (a step of preparing a polymeric material or immediately after a polymerization reaction) in a polymerization process for obtaining an electrolyte resin precursor, cerium oxide may be mixed into a polymeric material.

### SUMMARY

However, in JP 2009-286840 A, a polymeric material and cerium oxide are put into a container and stirred at a predetermined temperature and a predetermined pressure, or cerium oxide is additionally added to a container after a polymerization reaction and stirred for a predetermined time. Thereby, an electrolyte resin precursor in a state in which cerium oxide within a predetermined particle size range is mixed in is obtained. In an electrolyte film produced using such an electrolyte resin precursor, when stirring is insufficient, cerium may be localized, and deterioration of the electrolyte film due to peroxide radicals may not be sufficiently reduced. Such a problem is common to not only in a case in which cerium is used but also in a case in which an arbitrary material that can eliminate hydroxy radicals such as manganese (Mn) (hereinafter referred to as a “hydroxy radical elimination accelerator”) is used. Accordingly, a technology for reducing localization of the hydroxy radical elimination accelerator in an electrolyte film is desired.

An aspect of the present disclosure relates to a method of producing a membrane electrode assembly. The method of producing a membrane electrode assembly includes a process of obtaining a membrane body by forming an electrolyte resin precursor which is a precursor of an electrolyte resin used in an electrolyte film into a film form; and a hydrolysis process of obtaining the electrolyte film by hydrolyzing the membrane body. The hydrolysis process includes a process of passing the membrane body through a first tank in which an alkaline aqueous solution is accommodated and a process of passing the membrane body through second tanks in which an aqueous solution in which a water-soluble hydroxy radical elimination accelerator is dissolved in advance is accommodated after the membrane body is passed through the first tank.

According to the method of producing a membrane electrode assembly in this aspect, in the hydrolysis process, since the membrane body is passed through the second tanks in which an aqueous solution in which a hydroxy radical elimination accelerator is dissolved in advance is accommodated, the hydroxy radical elimination accelerator can finely and widely spread inside the membrane body during hydrolysis. Therefore, it is possible to reduce localization of the hydroxy radical elimination accelerator in the electrolyte film “Finely and widely spread” means that, for example, a plurality of particles that are spread apart at a single particle level are uniformly scattered (distributed) without aggregation. “Uniformly” is a wide concept that includes not only the meaning of “to have exactly the same content proportion in all places” but also the meaning of “to have a content proportion within a predetermined range in all places.”

The second tank may be at least one among a first water tank in which water for washing the membrane body that has passed through the first tank is accommodated, an acid tank in which an acidic aqueous solution through which the membrane body that has been washed in the first water tank is passed is accommodated, and a second water tank in which water for washing the membrane body that has passed through the acid tank is accommodated. According to this production method, the hydroxy radical elimination accelerator is dissolved in advance in at least one tank among the first water tank, the acid tank, and the second water tank. Thus, in the hydrolysis process, the hydroxy radical elimination accelerator can be reliably incorporated into the membrane body. In this specification, the hydrolysis process includes not only a process of hydrolysis with an acid, but also a process in an alkaline aqueous solution which is a pretreatment for hydrolysis, a process of removing an alkali for a hydrolysis treatment, and a process of removing an acid that is used in the hydrolysis treatment. In addition, the hydrolysis process may include a process of impregnating the aqueous solution of the hydroxy radical elimination accelerator into the electrolyte film after the acid is removed from the electrolyte film.

The second tank may be the second water tank. According to this production method, the second tank is the second water tank, that is, a tank which is used separately with respect to the first tank used when the hydrolysis process starts. Therefore, when the hydroxy radical elimination accelerator is incorporated, it is possible to reduce an influence on the hydrolysis process. Specifically, for example, it is possible to reduce a likelihood of some end groups of side chains of the electrolyte resin being replaced with some of the hydroxy radical accelerator, and proton conductivity being lowered.

The method of producing the membrane electrode assembly may further include a process of forming a catalyst layer on at least one of the two surfaces of the membrane body before the hydrolysis process. The hydrolysis process may include a process of passing the membrane body on which the catalyst layer is formed through the first tank and a process of passing the membrane body on which the catalyst layer is formed through the second tank after the membrane body on which the catalyst layer is formed is passed through the first tank. According to this production method, since the hydrolysis process is performed after the catalyst layer is formed on at least one surface between the two surfaces of the membrane body, the membrane body and the electrolyte resin in the catalyst layer are softened in the aqueous solution, and the adhesiveness at a boundary between the membrane body and the catalyst layer can be improved. Therefore, it is possible to improve the adhesiveness between the electrolyte film and the catalyst layer in the membrane electrode assembly obtained according to the production method.

The hydroxy radical elimination accelerator may be cerium nitrate. According to this production method, since cerium nitrate is used as the hydroxy radical elimination accelerator, it can dissolve in an aqueous solution in the second tank and can be widely dispersed, and it is possible to produce a membrane electrode assembly using a readily available material.

The present disclosure can also be realized in various forms. The present disclosure can be realized in the form of, for example, a method of producing an electrolyte film, a method of producing a membrane electrode diffusion layer assembly (MEGA), a method of producing a fuel cell, a device for producing a membrane electrode assembly, and a hydrolysis process device.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a sectional view schematically showing a fuel cell including a membrane electrode assembly produced by a method of producing a membrane electrode assembly as an embodiment of the present disclosure;

FIG. 2 is a flowchart showing a method of producing a membrane electrode assembly;

FIG. 3 is a flowchart showing procedures of a hydrolysis process in a first embodiment;

FIG. 4 is an explanatory diagram schematically showing a mode of a hydrolysis process in the first embodiment;

FIG. 5 is a flowchart showing a method of producing a membrane electrode assembly in a third embodiment; and

FIG. 6 is an explanatory diagram schematically showing a mode of a hydrolysis process in the third embodiment.

### DETAILED DESCRIPTION OF EMBODIMENTS

### A. First Embodiment

### A1. Configuration of Fuel Cell

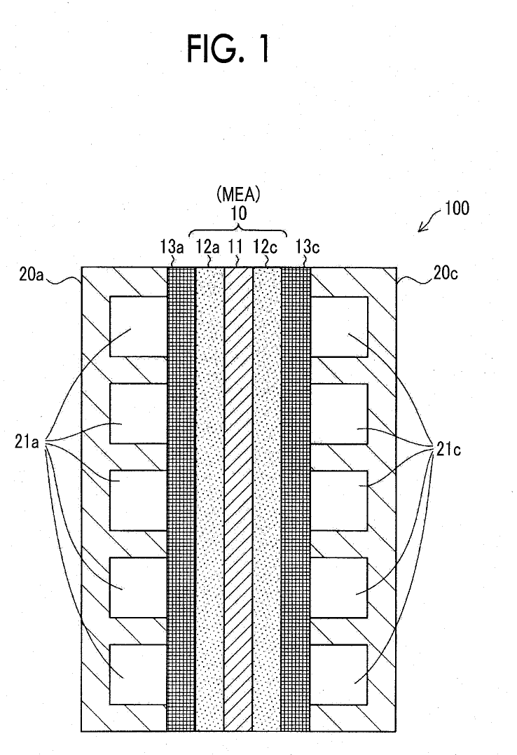

FIG. 1 is a sectional view schematically showing a fuel cell including a membrane electrode assembly produced by a method of producing a membrane electrode assembly according to an embodiment of the present disclosure. A fuel cell 100 is a single high polymer fuel cell in which hydrogen gas as a fuel gas and air as an oxidant gas are supplied as reaction gases and power is generated. Here, while only one fuel cell 100 is shown in FIG. 1, a lamination of a plurality of fuel cells 100 is generally used.

The fuel cell 100 includes a membrane electrode assembly (MEA) 10, an anode side gas diffusion layer 13a, a cathode side gas diffusion layer 13c, an anode side separator 20a, and a cathode side separator 20c.

The membrane electrode assembly 10 includes an electrolyte film 11, an anode side catalyst layer 12a, and a cathode side catalyst layer 12c. The electrolyte film 11 is formed of a thin film that includes an electrolyte resin exhibiting favorable proton conductivity in a wet state as a main component. The anode side catalyst layer 12a and the cathode side catalyst layer 12c are disposed to face each other with the electrolyte film 11 therebetween. These two catalyst layers 12a and 12c are formed using catalyst-supporting carbon that supports catalyst particles and an electrolyte resin as main components. As the catalyst, for example, platinum, may be used. As a carbon support, for example, carbon black may be used. In the present embodiment, the electrolyte resin used in the two catalyst layers 12a and 12c has the same composition as the electrolyte resin used in the electrolyte film 11. However, as will be described below, the electrolyte resin used in the two catalyst layers 12a and 12c differs from the electrolyte resin used in the electrolyte film 11 in that no hydroxy radical elimination accelerator is contained.

The anode side gas diffusion layer 13a and the cathode side gas diffusion layer 13c are disposed to face each other with the membrane electrode assembly 10 therebetween. The two gas diffusion layers 13a and 13c are made of a conductive member allowing excellent gas diffusibility. For example, it may be made of carbon cloth, carbon paper, or the like formed of a nonwoven fabric.

The anode side separator 20a and the cathode side separator 20c are disposed to face each other with the membrane electrode assembly 10 and the two gas diffusion layers 13a and 13c therebetween. These two separators 20a and 20c are made of a conductive member having excellent gas barrier properties (gas impermeability). For example, a rolled metal and sintered carbon may be used. A cross section of the anode side separator 20a has an uneven shape. When the anode side separator 20a is in contact with the membrane electrode assembly 10, a fuel gas flow path 21a is formed between the anode side separator 20a and the anode side gas diffusion layer 13a. Similarly, a cross section of the cathode side separator 20c has an uneven shape, and when the cathode side separator 20c is in contact with the membrane electrode assembly 10, an oxidant gas flow path 21c is formed between the cathode side separator 20c and the cathode side gas diffusion layer 13c.

In the fuel cell 100, hydrogen gas supplied from the fuel gas flow path 21a is diffused by the anode side gas diffusion layer 13a and is supplied to the anode side catalyst layer 12a, and additionally supplied to the electrolyte film 11. Some of hydrogen gas supplied to the electrolyte film 11 is not converted into protons, but passes through the electrolyte film 11 as hydrogen molecules, and is supplied to the cathode side catalyst layer 12c and reacts with oxygen molecules, and hydrogen peroxide (H₂O₂) is generated. In addition, in the cathode side catalyst layer 12c, hydrogen peroxide is radicalized and hydroxy radicals (.OH) may be generated. The hydroxy radicals decompose and damage the electrolyte film 11. However, as will be described below, a compound that eliminates hydroxy radicals or accelerates elimination of hydroxy radicals (hereinafter referred to as a “hydroxy radical elimination accelerator”) is incorporated into the electrolyte film 11 in advance. Therefore, damage to the electrolyte film 11 due to the hydroxy radicals in the cathode side catalyst layer 12c is reduced. In the present embodiment, when a membrane electrode assembly is produced by a method of producing a membrane electrode assembly to be described below, dispersibility of the hydroxy radical elimination accelerator in the electrolyte film 11 is improved and damage to the electrolyte film 11 due to the hydroxy radicals is more reliably reduced. Here, the hydroxy radical elimination accelerator will be described blow in detail.

### A2. Production of Membrane Electrode Assembly

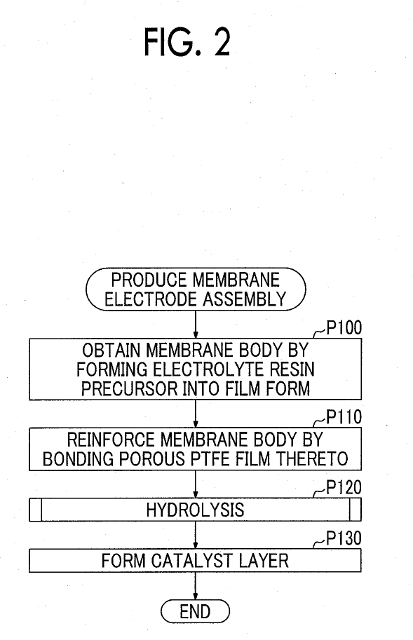

FIG. 2 is a flowchart showing a method of producing the membrane electrode assembly 10. First, an electrolyte resin precursor is formed into a film form to obtain a membrane body (process P100). In the present embodiment, the electrolyte resin precursor refers to a polymer compound having a functional group exhibiting proton conductivity according to hydrolysis which will be performed later. In the present embodiment, a precursor of a perfluorosulfonic acid polymer having a sulfonyl fluoride group (—SO₂F) in the side chain end is used as an electrolyte resin precursor (F type: F type is a type in which ions released from a functional group are fluorine ions). As a film formation method, an arbitrary method such as a solution casting method and an extrusion method may be used. In this case, a film may be formed on a back sheet. As the back sheet, a sheet made of a synthetic resin may be used. As the synthetic resin, for example, a fluororesin such as perfluoroalkoxy fluorine resin (PFA) and polyphenylene sulfide resin (PPS) may be used. Here, a film may be formed without using a back sheet.

A porous polytetrafluoroethylene (PTFE) film is bonded to the membrane body obtained in the process P100 to reinforce a membrane body (process P110). The porous PTFE film is a porous membrane member that contains PTFE as a main component, and when bonded to a membrane body, the electrolyte resin precursor is impregnated into pores of the porous PTFE film. Thus, when a cross section of the reinforced membrane body formed in the process P110 is observed, it has a 3-layer structure in which the electrolyte resin precursor, the porous PTFE film into which the electrolyte film precursor is impregnated, and the electrolyte film precursor are laminated in that order. In addition, when a back sheet is used in the process P100, it has a 4-layer structure including the back sheet.

A hydrolysis process is performed on the membrane body reinforced with the porous PTFE film (process P120).

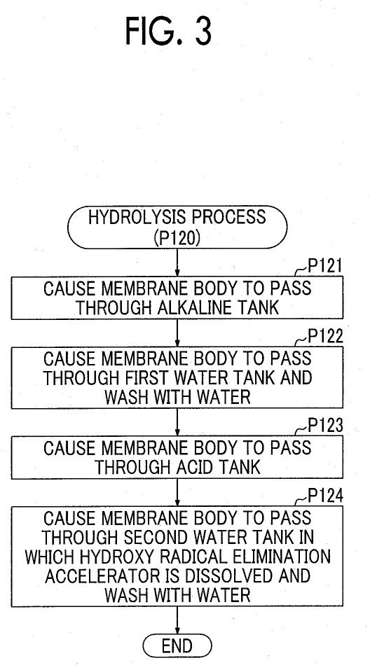

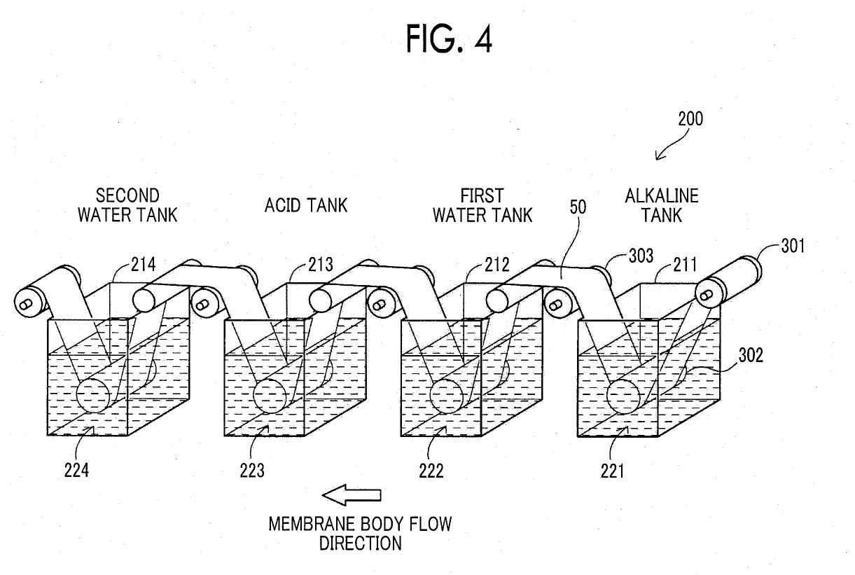

FIG. 3 is a flowchart showing procedures of a hydrolysis process in the first embodiment. FIG. 4 is an explanatory diagram schematically showing a mode of a hydrolysis process in the first embodiment.

In the hydrolysis process (process P120), as shown in FIG. 4, a hydrolysis process device 200 is used. The hydrolysis process device 200 includes an alkaline tank 211, a first water tank 212, an acid tank 213, a second water tank 214, and a membrane body transport device.

In the alkaline tank 211, a strongly alkaline aqueous solution 221 is accommodated. As the aqueous solution 221, for example, an aqueous solution in which sodium hydroxide (NaOH) or calcium hydroxide (Ca(OH)₂) is dissolved may be used.

When the production process starts, pure water 222 is accommodated in the first water tank 212.

A strongly acidic aqueous solution 223 is accommodated in the acid tank 213. As the aqueous solution 223, for example, an aqueous solution in which nitric acid (HNO₃), sulfuric acid (H₂SO₄), or hydrochloric acid (HCl) is dissolved may be used.

An aqueous solution 224 in which a water-soluble hydroxy radical elimination accelerator is dissolved in pure water is accommodated in the second water tank 214. As the hydroxy radical elimination accelerator, for example, cerium nitrate (Ce(NO₃)₃.6H₂O) may be used. In addition, the hydroxy radical elimination accelerator is not limited to cerium nitrate and an arbitrary water-soluble cerium compound may be used. In addition, a water-soluble compound of an arbitrary transition metal such as manganese (Mn) may be used without limitation to cerium. For example, manganese nitrate (Mn(NO₃)₂.6H₂O) may be used. For example, cerium (trivalent cerium ions) contained in cerium nitrate eliminates hydroxy radicals according to a chemical reaction shown in the following Formula 1.

Ce³⁺+.OH+H⁺→Ce⁴⁺+H₂O (1)

When cerium nitrate is used as the hydroxy radical elimination accelerator, since cerium nitrate is water-soluble, it can be dissolved in the aqueous solution 224 and be widely dispersed, and is a readily available material. Therefore, it is possible to reduce production costs of the membrane electrode assembly 10.

The membrane body transport device transports a membrane body 50 when the hydrolysis process is performed. The membrane body transport device includes a plurality of rollers that are provided in the vicinity of the treatment tanks 211 to 214, motors configured to drive the rollers, and a control device configured to control driving the motor. As shown in FIG. 4, in the vicinity of the alkaline tank 211, a first roller 301, a second roller 302, and a third roller 303 are disposed. The first roller 301 guides the membrane body 50 after the process P110 is performed into the alkaline tank 211. The second roller 302 is disposed in the alkaline tank 211, and transports the membrane body 50 unfolded from the first roller 301 into the aqueous solution 221. The third roller 303 is disposed between the alkaline tank 211 and the first water tank 212, and transports the membrane body 50 unfolded from the second roller 302 toward the first water tank 212. In the vicinity of the other three treatment tanks 212 to 214, rollers the same as the above three rollers 301 to 303 are disposed.

As shown in FIG. 3 and FIG. 4, in the hydrolysis process, first, the membrane body 50 is caused to pass through the alkaline tank 211 (process P121). For example, when the aqueous solution 221 is an aqueous sodium hydroxide solution, a sulfonyl fluoride group (—SO₂F) of the side chain end of the electrolyte resin that forms the membrane body 50 is replaced with a sodium sulfonyl group (—SO₃Na).

The membrane body 50 that has passed through the alkaline tank 211 is passed through the first water tank 212 and is washed with water (process P122). The process P122 is performed to remove alkaline aqueous solution attached to the surface of the membrane body 50 before the membrane body 50 passes through the acid tank 213. Alternatively, the process P122 may be omitted.

The membrane body 50 that has passed through the first water tank 212 is passed through the acid tank 213 (process P123). According to such a treatment, a sulfonic acid group (—SO₃H) is substituted on the side chain end of the electrolyte resin that forms the membrane body 50.

The membrane body 50 that has passed through the acid tank 213 is passed through the second water tank 214 and is washed with water (process P124). This process is performed to remove acidic aqueous solution attached to the surface of the membrane body 50 before a process (catalyst layer forming process) after the hydrolysis process and to finely and widely spread the hydroxy radical elimination accelerator in the membrane body 50. “Finely and widely spread” means that, for example, a plurality of particles that are spread apart at a single particle level are uniformly scattered (distributed) without aggregation. “Uniformly” is a wide concept that includes not only the meaning of “to have exactly the same content proportion in all places” but also the meaning of “to have a content proportion within a predetermined range in all places.” As described above, the hydroxy radical elimination accelerator is dissolved in the aqueous solution 224 in the second water tank 214. Therefore, when the membrane body 50 passes through the aqueous solution 224, the hydroxy radical elimination accelerator can finely and widely spread in the membrane body 50. Here, the hydroxy radical elimination accelerator that is dissolved in pure water spreads in a fine state, in other words, at a molecular level, in the aqueous solution 224. Therefore, when the membrane body 50 passes through the aqueous solution 224, the hydroxy radical elimination accelerator finely and widely spreads inside the membrane body 50. Upon completion of the process P124, the hydrolysis process ends.

As shown in FIG. 2, after the hydrolysis process (process P120) is completed, a catalyst layer is formed on both surfaces of the membrane body 50 (process P130). As a method of forming a catalyst layer, a known method can be used. For example, a method in which a catalyst ink obtained by mixing a catalyst support (for example, platinum-supporting carbon) and an electrolyte resin into a solvent is applied to the surface of the membrane body 50 after the process P120 and dried may be used. Here, when a back sheet is used in the process P100, on one surface of the membrane body 50, the back sheet is peeled off and a catalyst layer is formed. Here, a drying process may be added between the process P120 and the process P130. When the catalyst layer is formed in the process P130, the membrane electrode assembly 10 is completed.

On both surfaces of the membrane electrode assembly 10 obtained in this manner, the pair of gas diffusion layers 13a and 13c are disposed, and, the pair of separators 20a and 20c are additionally disposed, and thereby the fuel cell 100 is completed.

According to the method of producing a membrane electrode assembly in the first embodiment described above, in the hydrolysis process, the membrane body 50 is passed through the second water tank 214 in which the aqueous solution 224 in which the hydroxy radical elimination accelerator is dissolved in advance is accommodated. Therefore, during hydrolysis, the hydroxy radical elimination accelerator can finely and widely spread inside the membrane body 50. Therefore, for example, compared to a method (hereinafter referred to as a “comparative method”) in which a hydroxy radical elimination accelerator is kneaded in advance into an electrolyte resin precursor, a membrane body is obtained using the electrolyte resin precursor, and the hydroxy radical elimination accelerator is distributed in the electrolyte film, localization of the hydroxy radical elimination accelerator in the electrolyte film 11 can be reduced. In the comparative method, for example, before a polymerization process for obtaining an electrolyte resin precursor, a process of distributing the hydroxy radical elimination accelerator in the electrolyte resin precursor by kneading an electrolyte resin material and the hydroxy radical elimination accelerator is assumed, or, after the polymerization process, a process of distributing the hydroxy radical elimination accelerator in the electrolyte resin precursor by adding the hydroxy radical elimination accelerator and performing kneading is assumed. In such a comparative method, if sufficient kneading is not performed, there is a risk of localization of the hydroxy radical elimination accelerator. For example, before the polymerization process, when cerium oxide as the hydroxy radical elimination accelerator is mixed into the electrolyte resin material, since the cerium oxide is provided as relatively large particles with an approximately submicrometer (0.1 μm to 1.0 μm) average particle size, localization of cerium is likely to occur. According to the production method of the first embodiment, for example, since cerium nitrate as the hydroxy radical elimination accelerator is dissolved in the aqueous solution 224, the cerium nitrate is present at a molecular level in the aqueous solution 224. Thus, even if there is no process such as kneading, when the membrane body 50 passes through the aqueous solution 224, cerium nitrate can finely and widely spread.

In addition, according to the method of producing a membrane electrode assembly in the first embodiment, since the electrolyte resin precursor does not contain the hydroxy radical elimination accelerator in the process of forming an electrolyte resin precursor into a film form (process P100), it is possible to reduce the amount of hydroxy radical elimination accelerator that remains on a lip of an extrusion die when an extrusion method is used in the process. In addition, when a solution casting method is used in the process, it is possible to reduce the amount of hydroxy radical elimination accelerator that remains on a lip of a device configured to discharge a solution.

In addition, according to the method of producing a membrane electrode assembly in the first embodiment, since the tank in which the aqueous solution in which the hydroxy radical elimination accelerator is dissolved is accommodated is a treatment tank that is used in the final process in the hydrolysis process, in other words, a treatment tank in which an aqueous solution that is used in a process after an alkali treatment and an acid treatment is accommodated, and additionally, in other words, the second water tank 214 which is a treatment tank separate from the alkaline tank 211, it is possible to reduce an influence on the hydrolysis process due to incorporation of the hydroxy radical elimination accelerator. Specifically, after passing through the acid tank 213 and the end group of the side chain being replaced with a sulfonic acid group (—SO₃H), the membrane body 50 passes through the second water tank 214 in which cerium nitrate is dissolved. Therefore, it is possible to reduce a likelihood of the end group of the side chain being replaced with cerium and reduce a decrease in proton conductivity.

### B. Second Embodiment

A method of producing a membrane electrode assembly in a second embodiment differs from the method of producing a membrane electrode assembly in the first embodiment in that a hydroxy radical elimination accelerator is dissolved in the aqueous solution 223 that is accommodated in the acid tank 213 in place of the aqueous solution 224 that is accommodated in the second water tank 214. The other procedures in the method of producing a membrane electrode assembly in the second embodiment, and a configuration of the hydrolysis process device 200 are the same as those in the first embodiment, and thus details thereof will not be described.

The hydroxy radical elimination accelerator dissolved in the aqueous solution 223 is the same as in the first embodiment. That is, for example, a water-soluble compound of an arbitrary transition metal such as cerium nitrate or manganese nitrate may be used.

Also in the method of producing a membrane electrode assembly in the second embodiment having the above configuration, the membrane body 50 that has passed through the alkaline tank 211 in the hydrolysis process is passed through the acid tank 213 in which the aqueous solution 223 in which the hydroxy radical elimination accelerator is dissolved in advance is accommodated. Therefore, the same effect as in the method of producing a membrane electrode assembly in the first embodiment is obtained. Here, in the second embodiment, the process P124 may be omitted.

### C. Third Embodiment

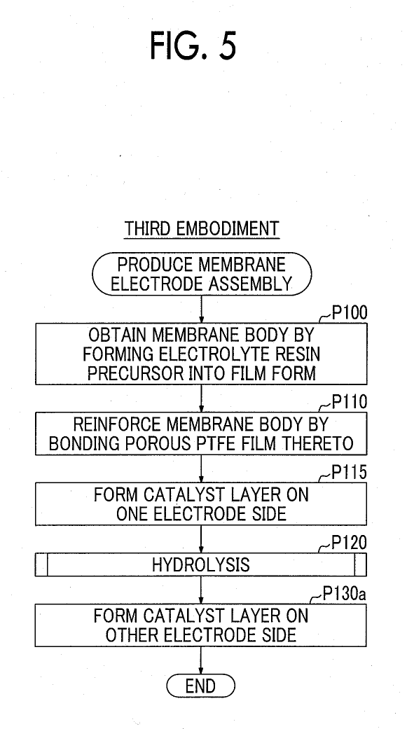

FIG. 5 is a flowchart showing a method of producing a membrane electrode assembly in a third embodiment. The method of producing a membrane electrode assembly in the third embodiment differs from the method of producing a membrane electrode assembly in the first embodiment shown in FIG. 2 in that a film is formed using a back sheet in the process P100, a process P115 is added and performed, and a process P130a is performed in place of the process P130. Since the other processes in the method of producing a membrane electrode assembly in the third embodiment are the same as those in the first embodiment, the same processes are denoted with the same reference numerals and thus details thereof will not be described. Here, since a membrane electrode assembly produced by the method of producing a membrane electrode assembly of the third embodiment is the same as the membrane electrode assembly 10 of the first embodiment shown in FIG. 1, the same components are denoted with the same reference numerals and thus details thereof will not be described.

As shown in FIG. 5, after the process P110 is performed, a catalyst layer is formed on one surface of the membrane body 50 (process P115). Specifically, on a surface on which no back sheet is formed between both surfaces of the membrane body 50, a catalyst layer of one electrode side is formed. A method of forming a catalyst layer is the same as the method of the process P130 in the first embodiment, and thus details thereof will not be described.

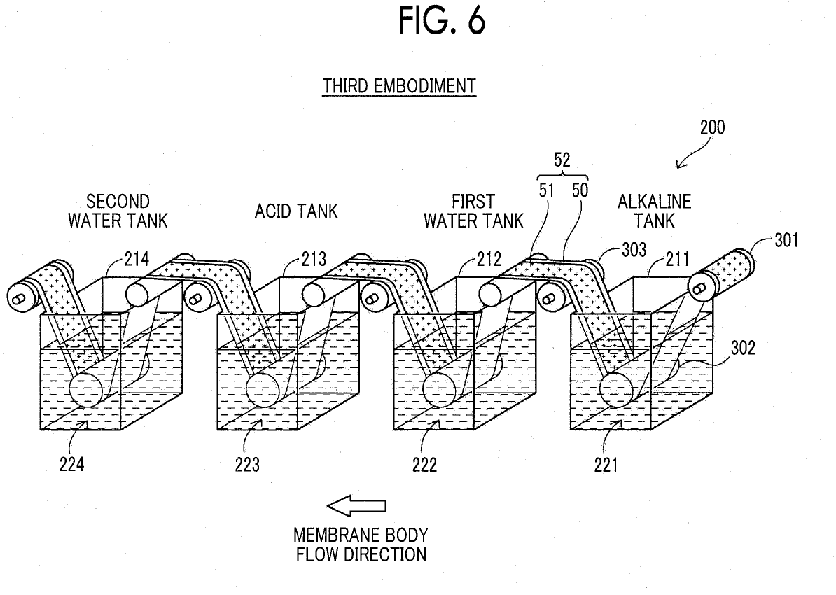

FIG. 6 is an explanatory diagram schematically showing a mode of a hydrolysis process in the third embodiment. Since the hydrolysis process device 200 in the third embodiment is the same as the hydrolysis process device 200 in the first embodiment shown in FIG. 4, the same components are denoted with the same reference numerals and thus details thereof will not be described.

As shown in FIG. 6, in the hydrolysis process (process P120), a catalyst layer forming membrane body 52 including the membrane body 50 and a catalyst layer 51 that is formed on one surface of the membrane body 50 passes through the treatment tanks 211 to 214. In this case, the membrane body 50 and the catalyst layer 51 are softened when they pass through treatment solutions (aqueous solutions) in the treatment tanks 211 to 214, and the adhesiveness at a boundary between the membrane body 50 and the catalyst layer 51 is improved.

As shown in FIG. 5, after the hydrolysis process (process P120), a catalyst layer is formed on the other surface of the membrane body 50 (the catalyst layer forming membrane body 52) (process P130a). The process P130a differs from the process P130 in the first embodiment only in that a catalyst layer is formed on one surface between both surfaces of the membrane body 50 (the catalyst layer forming membrane body 52). After the process P130a is completed, the method of producing a membrane electrode assembly is completed.

The method of producing the membrane electrode assembly 10 in the third embodiment described above has the same effect as the method of producing the membrane electrode assembly 10 in the first embodiment. In addition, since the hydrolysis process is performed after the catalyst layer 51 is formed on one surface between both surfaces of the membrane body 50, the membrane body 50 and the catalyst layer 51 are softened in an aqueous solution and the adhesiveness at a boundary between the membrane body 50 and the catalyst layer 51 can be improved. Therefore, it is possible to improve the adhesiveness between the electrolyte film 11 and the catalyst layer (the anode side catalyst layer 12a or the cathode side catalyst layer 12c) in the membrane electrode assembly 10 obtained according to the production method.

### D. EXAMPLES

### D1. First Example

The electrolyte film 11 (hereinafter referred to as a “sample 1”) according to the first embodiment was produced, a known Fenton's test was performed, and a degree of deterioration of the electrolyte film 11 was evaluated. Similarly, the electrolyte film 11 (hereinafter referred to as a “sample 2”) according to the second embodiment was produced, and a Fenton's test was performed in the same manner. In addition, an electrolyte film (hereinafter referred to as a “sample 3”) of a comparative example was produced and a Fenton's test was performed.

Specifically, the sample 1 was produced as follows. In the process P100, the membrane body 50 was formed on a PFA sheet by a solution casting method. In the process P110, a porous PTFE film with a porosity of 60% was bonded to the membrane body 50 and dried, and the membrane body 50 with a thickness (thickness except for the PFA sheet) of 10 μm after drying was obtained. The aqueous solution 221 in the alkaline tank 211 was an aqueous solution in which sodium hydroxide was dissolved in pure water. A content proportion of sodium hydroxide in the aqueous solution 221 was about 30 wt %. A temperature of the aqueous solution 221 was 25° C. The aqueous solution 223 in the acid tank 213 was an aqueous solution in which nitric acid was dissolved in pure water. A content proportion of nitric acid in the aqueous solution 223 was 10 wt %. Heat control was performed so that the aqueous solution 223 was maintained at 50° C. The aqueous solution 224 in the second water tank 214 was obtained by dissolving cerium nitrate as the hydroxy radical elimination accelerator in pure water. A content proportion of cerium nitrate in the aqueous solution 224 was 0.05 wt %. The temperatures of the aqueous solution 224 and the pure water 222 in the first water tank 212 were both normal temperature. A content of cerium in the sample 1 was 0.2 μg/cm².

The sample 2 was produced under the same production conditions as in the sample 1 except for the following two differences. That is, the first difference was that the aqueous solution 223 in the acid tank 213 was an aqueous solution obtained by dissolving cerium nitrate as a hydroxy radical elimination accelerator in nitric acid and pure water. A content proportion of nitric acid in the aqueous solution 223 was 10 wt %. An average content proportion of cerium nitrate in the aqueous solution 223 was 0.05 wt %. The second difference was that the aqueous solution 224 in the second water tank 214 was formed of only pure water.

The sample 3 was produced under the same production conditions as in the sample 1 except for the following difference. That is, no hydroxy radical elimination accelerator (cerium nitrate) was dissolved in all of the treatment tanks 211 to 214.

The Fenton's test was performed under the following conditions. That is, the samples 1 to 3 were cut into 4 cm×5 cm sample pieces, immersed in a Fenton's test solution, and left in a temperature environment of 80° C. for 8 hours. Then, an elution amount of fluorine ions in the test solution was measured. When the measured elution amount of fluorine ions was larger, a degree of deterioration of a sample piece (electrolyte film) could be evaluated as being higher. Here, in the Fenton's test solution, a content proportion of hydrogen peroxide (H₂O₂) was 1% and a content proportion of Fe²⁺ as a deterioration accelerator was 100 ppm.

The following Table 1 shows results of the Fenton's test of the samples 1 to 3. Here, Table 1 shows values of elution amounts (content proportion in the test solution) of fluorine ions, which are represented as a normalized value when an elution amount of fluorine ions of the sample 3 (Comparative Example 1) was set as 100 (ppm). As shown in Table 1, compared to the sample 3 of Comparative Example 1, in both the sample 1 and the sample 2, an elution amount of fluorine ions was very small. That is, it can be understood that deterioration of the electrolyte film was greatly reduced. This is inferred to have been caused by the fact that cerium nitrate spread finely and widely as the hydroxy radical elimination accelerator in the electrolyte film 11.

TABLE 1

| | Elution amount of fluorine ions |
|---|---|
| Sample 1 | 0.6 |
| Sample 2 | 0.9 |
| Sample 3 | 100 |

### D2. Second Example

The membrane electrode assembly 10 (hereinafter referred to as a “sample 4”) according to the third embodiment was produced, a Fenton's test was performed, and a degree of deterioration of the fuel cell 100 was evaluated. Similarly, the membrane electrode assembly 10 (hereinafter referred to as a “sample 5”) according to the second embodiment was produced, and a Fenton's test was performed in the same manner. In addition, a membrane electrode assembly (hereinafter referred to as a “sample 6”) of a comparative example was produced and a Fenton's test was performed.

Specifically, the sample 4 was produced as follows. In the process P100, the membrane body 50 was formed on a PFA sheet by a solution casting method. In the process P110, a porous PTFE film with a porosity of 60% was bonded to the membrane body 50 and dried, and the membrane body 50 with a thickness (thickness except for the PFA sheet) of 10 μm after drying was obtained. In the process P115, a catalyst ink was applied to one surface (a surface opposite to a side to which a PFA sheet was attached) of the membrane body 50 and dried to form a catalyst layer. As the catalyst, platinum (Pt) was used. The catalyst ink was obtained by mixing platinum-supporting carbon, an electrolyte resin precursor (F type), and a solvent and performing ultrasonic dispersion. An amount of platinum in the catalyst layer was 0.3 mg/cm². The aqueous solution 221 in the alkaline tank 211 was an aqueous solution in which sodium hydroxide was dissolved in pure water. A content proportion of sodium hydroxide in the aqueous solution 221 was about 30 wt %. A temperature of the aqueous solution 221 was 25° C. The aqueous solution 223 in the acid tank 213 was an aqueous solution in which nitric acid was dissolved in pure water. A content proportion of nitric acid in the aqueous solution 223 was 10 wt %. Heat control was performed so that the aqueous solution 223 was maintained at 50° C. The aqueous solution 224 in the second water tank 214 was obtained by dissolving cerium nitrate as the hydroxy radical elimination accelerator in pure water. A content proportion of cerium nitrate in the aqueous solution 224 was 0.05 wt %. The temperatures of the aqueous solution 224 and the pure water 222 in the first water tank 212 were both normal temperature. An average content of cerium in the electrolyte film 11, the anode side catalyst layer 12a, and the cathode side catalyst layer 12c in the sample 4 was 0.2 μg/cm². In the process P130a, a catalyst layer on the other electrode side was formed by a transfer method. An amount of platinum in the catalyst layer was 0.1 mg/cm².

The sample 5 was produced under the same production conditions as in the sample 4 except for the following two differences. That is, the first difference was that the aqueous solution 223 in the acid tank 213 was an aqueous solution obtained by mixing nitric acid, pure water, and cerium nitrate as the hydroxy radical elimination accelerator. A content proportion of nitric acid in the aqueous solution 223 was 10 wt %. An average content proportion of cerium nitrate in the aqueous solution 223 was 0.05 wt %. The second difference was that the aqueous solution 224 in the second water tank 214 was formed of only pure water.

The sample 6 was produced under the same production conditions as in the sample 4 except for the following difference. That is, no hydroxy radical elimination accelerator (cerium nitrate) was dissolved in the treatment tanks 211 to 214.

Conditions of the Fenton's test were the same as in the above first example, and thus details thereof will not be described.

The following Table 2 shows results of the Fenton's test of the samples 4 to 6. Table 2 shows values of elution amounts (content proportion in the test solution) of fluorine ions which were normalized with respect to 100 (ppm) of an elution amount of fluorine ions of the sample 6 (Comparative Example 2). As shown in Table 2, compared to the sample 6 of Comparative Example 2, in both the samples 4 and 5, an elution amount of fluorine ions was very small. That is, it can be understood that deterioration of the electrolyte film and the catalyst layer was greatly reduced. Like the results of the first example shown in Table 1, the results were inferred to have been caused by the fact that cerium nitrate finely and widely spread as the hydroxy radical elimination accelerator in the electrolyte film 11 and cerium nitrate also finely and widely spread in one catalyst layer.

TABLE 2

| | Elution amount of fluorine ions |
|---|---|
| Sample 4 | 1.3 |
| Sample 5 | 2.1 |
| Sample 6 | 100 |

### D3. Third Example

A fuel cell (hereinafter referred to as a “sample 7”) was produced using the sample 4. In addition, a fuel cell (hereinafter referred to as a “sample 8”) using the sample 5 was produced. In addition, a fuel cell (hereinafter referred to as a “sample 9”) of a comparative example (Comparative Example 3) was produced. Then, a power generation performance test was performed on these three fuel cells (the samples 7 to 9).

The samples 7 and 8 were produced by additionally providing a pair of gas diffusion layers and a pair of separators in a sandwich manner with respect to the samples 4 and 5.

Specifically, the sample 9 was produced as follows. First, the electrolyte film 11 was produced under the same production conditions as in the sample 1. However, a speed at which the membrane body 50 passed through the second water tank 214 (the aqueous solution 224) was adjusted so that a content proportion of cerium in the obtained electrolyte film 11 was 0.18 μg/cm². Then, a catalyst ink in which cerium nitrate was added was applied to the electrolyte film 11 and dried, and a catalyst layer on one electrode side was formed on one surface of the electrolyte film 11. As the catalyst, platinum (Pt) was used. The catalyst ink was obtained by mixing platinum-supporting carbon, an electrolyte resin precursor (F type), cerium nitrate, and a solvent, and performing ultrasonic dispersion. An amount of cerium nitrate added was adjusted so that a weight after cerium nitrate was applied and dried was 0.02 μg/cm². Then, a catalyst layer on the other electrode side was formed by a transfer method. An amount of platinum in the catalyst layer was 0.1 mg/cm². The membrane electrode assembly obtained by forming catalyst layers on both electrodes was provided with the pair of gas diffusion layers and the pair of separators therebetween and thereby a fuel cell of the sample 9 was produced.

In the power generation performance test, a reaction gas was supplied to the samples 7 to 9, power was generated, a voltage value at which a current density was 2.0 A/cm² was measured, and evaluation was performed based on the measured value. When the measured voltage value was higher, power generation performance was evaluated as being higher.

The following Table 3 show results of the power generation performance test of the samples 7 to 9. Table 3 shows voltage values with a current density of 2.0 A/cm² of the samples 7 to 9, which are represented as a normalized voltage value when a measured voltage value of the sample 9 (Comparative Example 3) was set as 100. As shown in Table 3, it can be understood that voltage values of the samples 7 and 8 were higher than a voltage value of the sample 9, and power generation performances of the samples 7 and 8 was higher than a power generation performance of the sample 9. This is inferred to have been caused by the fact that, in the samples 7 and 8, since a catalyst layer was formed on one surface of the electrolyte film before the hydrolysis process, the adhesiveness between the catalyst layer and the electrolyte film 11 was improved when passing through an aqueous solution or pure water in each treatment tank in the hydrolysis process.

TABLE 3

| | Voltage |
|---|---|
| Sample 7 | 102.3 |
| Sample 8 | 101.5 |
| Sample 9 | 100 |

### E. Other Embodiments

E1. In the embodiments, the process P110 may be omitted. That is, there is no need to reinforce the membrane body with a porous PTFE film. In addition, in the third embodiment, when the membrane body is formed without using a back sheet such as a PFA sheet in the process P100, a catalyst layer may be formed on both electrode sides in the process P115, and the process P130a may be omitted. In such a configuration, since the adhesiveness between the catalyst layers 12a and 12c on both electrode sides and the electrolyte film 11 in the hydrolysis process (process P120) can be improved, it is possible to further improve power generation performance.

E2. In the first and third embodiments, among the treatment tanks 211 to 214 used in the hydrolysis process, cerium nitrate is dissolved in advance in an aqueous solution to be accommodated (the aqueous solution 224) only in the second water tank 214. In addition, in the second embodiment, among the treatment tanks 211 to 214, cerium nitrate is dissolved in advance in an aqueous solution to be accommodated (the aqueous solution 223) only in the acid tank 213. However, the present disclosure is not limited thereto. For example, cerium nitrate may be dissolved in the pure water 222 in the first water tank 212. In addition, for example, like two treatment tanks of the aqueous solution 223 in the acid tank 213 and the aqueous solution 224 in the second water tank 214, cerium nitrate may be dissolved in an aqueous solution that is accommodated in an arbitrary number of treatment tanks among the other treatment tanks 212 to 214 excluding the alkaline tank 211. That is, generally, a process in which the membrane body 50 is passed through the alkaline tank 211 and is then passed through an arbitrary tank in which an aqueous solution in which a water-soluble hydroxy radical elimination accelerator is dissolved in advance is accommodated can be applied to the method of producing a membrane electrode assembly of the present disclosure.

The present disclosure is not limited to the embodiments, and can be realized in various configurations without departing from the scope of the prevent disclosure. For example, technical features in embodiments corresponding to technical features in aspects described in the summary can be appropriately replaced or combined in order to achieve some or all of the objects or achieve some or all of the effects. For example, in FIG. 4, no water-soluble hydroxy radical elimination accelerator may be dissolved in the first water tank 212, the acid tank 213, and the second water tank 214, an acid that is used for hydrolysis in the second water tank may be washed off, and then the membrane body may be passed through a tank in which an aqueous solution in which a water-soluble hydroxy radical elimination accelerator is dissolved is accommodated. In addition, when the technical features are not described as essential features in this specification, they can be appropriately omitted.

What is claimed is:

1. A method of producing a membrane electrode assembly including an electrolyte film, comprising:
a process of obtaining a membrane body by forming an electrolyte resin precursor which is a precursor of an electrolyte resin used in the electrolyte film into a film form; and
a hydrolysis process of obtaining the electrolyte film by hydrolyzing the membrane body,
wherein the hydrolysis process includes a process of passing the membrane body through a first tank in which an alkaline aqueous solution is accommodated, and a process of passing the membrane body through second tanks in which an aqueous solution in which a water-soluble hydroxy radical elimination accelerator is dissolved in advance is accommodated after the membrane body is passed through the first tank.

2. The method according to claim 1, wherein the second tank is at least one among a first water tank in which water for washing the membrane body that has passed through the first tank is accommodated, an acid tank in which an acidic aqueous solution through which the membrane body that has been washed in the first water tank is passed is accommodated, and a second water tank in which water for washing the membrane body that has passed through the acid tank is accommodated.

3. The method according to claim 2, wherein the second tank is the second water tank.

4. The method according to claim 1, further comprising:
a process of forming a catalyst layer on at least one of two surfaces of the membrane body before the hydrolysis process,
wherein the hydrolysis process includes a process of passing the membrane body on which the catalyst layer is formed through the first tank, and a process of passing the membrane body on which the catalyst layer is formed through the second tank after the membrane body on which the catalyst layer is formed is passed through the first tank.

5. The method according to claim 1, wherein the hydroxy radical elimination accelerator is cerium nitrate.
